(19) United States
(12) Patent Application Publication
(10) Pub. No.: US 2011/0012859 A1
(43) Pub. Date: Jan. 20, 2011

(54) RESISTANCE TYPE TOUCH PANEL

(75) Inventors: WEN-KUEI LAI, CHANGHUA COUNTY (TW); SHIH-HSIN JUAN, HSINCHU CITY (TW); CHENG-HSIN LU, HSINCHU COUNTY (TW); WEI-LUNG HUANG, KAOSIUNG COUNTY (TW); YI-CHEN LO, TAIPEI CITY (TW); CHIH-JUNG CHEN, PINGTUNG CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: ULTRA CHIP INC., TAIPEI CITY (TW)

(21) Appl. No.: 12/631,121

(22) Filed: Dec. 4, 2009

(30) Foreign Application Priority Data
Jul. 14, 2009 (TW) 098212790

(51) Int. Cl. G06F 3/045

(52) U.S. Cl. 345/174

(57) ABSTRACT

A resistance type touch panel includes a first substrate, a second substrate and a detection module. The first substrate further includes a touch module at a bottom surface thereof facing the second substrate, in which the touch module has a plurality of conductive blocks having individual signal lines. The second substrate includes a bias-layer module at an upper surface thereof opposing to the touch module by a predetermined spacing. The bias-layer module further includes at least four bias points accounted for at least two voltage biases along two directions. The detection module is electrically coupled with the signal lines of the touch module for realizing all the voltage changes among the conductive blocks.

This application claims the benefit of Taiwan Patent Application Serial No. 98212790, filed Jul. 14, 2009, the subject matter of which is incorporated herein by reference.

### BACKGROUND OF THE INVENTION

(1) Field of the Invention

The invention relates to a touch panel, and more particularly to the resistance type touch panel.

(2) Description of the Prior Art

Touch panels are widely applied to modern electronic devices such as personal digital assistances (PDA), mobile phones, notebook computers, industrial computers and so on. Currently, various types of the touch panels can be seen in the marketplace, including at least the capacitance type, the resistance type, the optical type, the electromagnetic digitizer type and so on; in which the resistance type touch panel is the concern in the following discussion.

The resistance type touch panel is known in which the data is outputted by depressing at or touching (by a finger or stylus) a position on a 2-dimensional coordinate system of the panel. In the touch panel, when a position on the touch panel is touched, an electrode film on an upper side of the panel is deflected simultaneously to touch an electrode film on a lower side of the touch panel at a respective location so that an electrically conductive path is formed between the electrode films. Precisely, the position of the electrically conductive path corresponds to 2-dimensional coordinates of the position by the aforesaid touch.

Referring now to FIG. 1, an exploded view of a conventional resistance type touch panel 100. The touch panel 100 includes mainly a first substrate 11, a second substrate 12 opposing to the first substrate 11 by a predetermined spacing (generally a spacer with a predetermined thickness, not shown in this figure) and a detection module 13.

On a lower surface of the first substrate 11, which the lower surface is the surface thereof facing the second substrate 12, a first electrode film is formed in a central portion of the first substrate 11. Along a first direction S1, two first electrodes 111 connected to the first electrode film are formed to oppose to each other around the first electrode firm on the lower surface of the first substrate 11. Two first wiring lines 112 connect individually and electrically the two first electrodes 111 to the detection module 13.

Counter to the first substrate 11, on an upper surface of the second substrate 12, which the upper surface is the surface thereof facing the first substrate 11, a second electrode film is formed in a central portion of the second substrate 12. Along a second direction S2 orthogonally to the first direction S1, two second electrodes 121 connected to the second electrode film are formed to oppose to each other around the second electrode firm on the upper surface of the second substrate 12. Two second wiring lines 122 connect individually and electrically the two second electrodes 121 to the detection module 13.

Normally, a bias voltage is alternatively provided to the first electrode film and the second electrode film, with respect to a common ground. Upon such an arrangement, a homogeneous voltage field is to appear periodically at the first electrode film between the two first electrodes 111 and at the second electrode film between the two second electrodes 121.

At a moment that the point P1 at the first substrate 11 is depressed by any means further downward to touch the respective point P2 at the second substrate 12, an electrically conductive path is established between P1 and P2. At this moment, while the aforesaid bias voltage is provided to the first substrate 11, a signal in the second substrate 12 for realizing the position of P2 along the S1 direction is generated by a resistance analysis manner and immediately forwarded to the detection module 13 through the second wiring lines 122. Thereby, the S1-coordinate of the point P1 or P2 can be computed and read by the detection module 13. Similarly, also at this moment but in another time, while the aforesaid bias voltage is provided to the second substrate 12, a signal in the first substrate 12 for realizing the position of P1 along the S2 direction is generated by a resistance analysis manner and immediately forwarded to the detection module 13 through the first wiring lines 112. Thereby, the S2-coordinate of the point P1 or P2 can be computed read by the detection module 13. By integrating the realized S1-coordinate and S2-coordinate, the precise position of the touch at P1 (also P2) can be located.

It is clear that the aforesaid arrangement of the touch panel, who provides only a pair of wiring lines to transmit the signal, can only read a touch at a single time. If two touches happen precisely coincidentally at the first substrate 11, say at P1 and P2 as shown, the detection module 13 would be no way to tell two different positions from a single voltage output forwarded by the wiring 112 or 122. Definitely, it is the shortcoming of the aforesaid touch panel, which needs to be overcome as soon as possible.

### SUMMARY OF THE INVENTION

Accordingly, it is an object of the present invention to provide a resistance type touch panel that includes a plurality of conductive blocks to facilitate the detections of plural touch points.

In the present invention, the resistance type touch panel includes a first substrate, a second substrate and a detection module. The first substrate further includes a touch module at a bottom surface thereof facing the second substrate, in which the touch module has a plurality of conductive blocks, insulated electrically to each other. Each of the conductive blocks has a signal line. The second substrate includes a bias-layer module at an upper surface thereof opposing to the touch module by a predetermined spacing. The bias-layer module further includes at least four bias points accounted for at least two voltage biases along two directions, preferably two orthogonal directions. The detection module is electrically coupled with the signal lines of the touch module at the first substrate for realizing all the voltage changes among the conductive blocks.

In the present invention, the resistance type touch panel further includes a control module to provide bias voltages to the bias points and to help the voltage reading and touch position-judgment in the detection module.

By providing the touch module with discrete conductive blocks and respective signal lines to the first substrate of the touch panel, multiple coincident touches to respective conductive blocks can then be realized by the detection module.

All these objects are achieved by the resistance type touch module described below.

### BRIEF DESCRIPTION OF THE DRAWINGS

The present invention will now be specified with reference to its preferred embodiment illustrated in the drawings, in which:

FIG. 1 is an exploded view of a conventional resistance type touch panel;

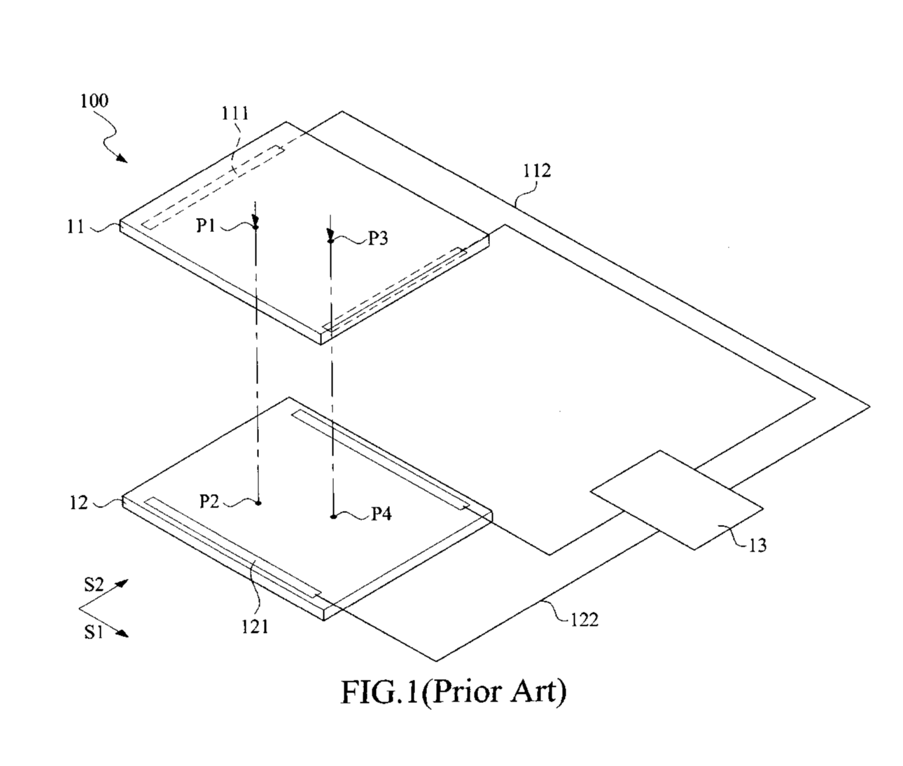

FIG. 2 is an exploded view of a first embodiment of the resistance type touch panel in accordance with the present invention; and

FIG. 3 is an exploded view of a second embodiment of the resistance type touch panel in accordance with the present invention.

### DESCRIPTION OF THE PREFERRED EMBODIMENT

The invention disclosed herein is directed to a resistance type touch panel. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

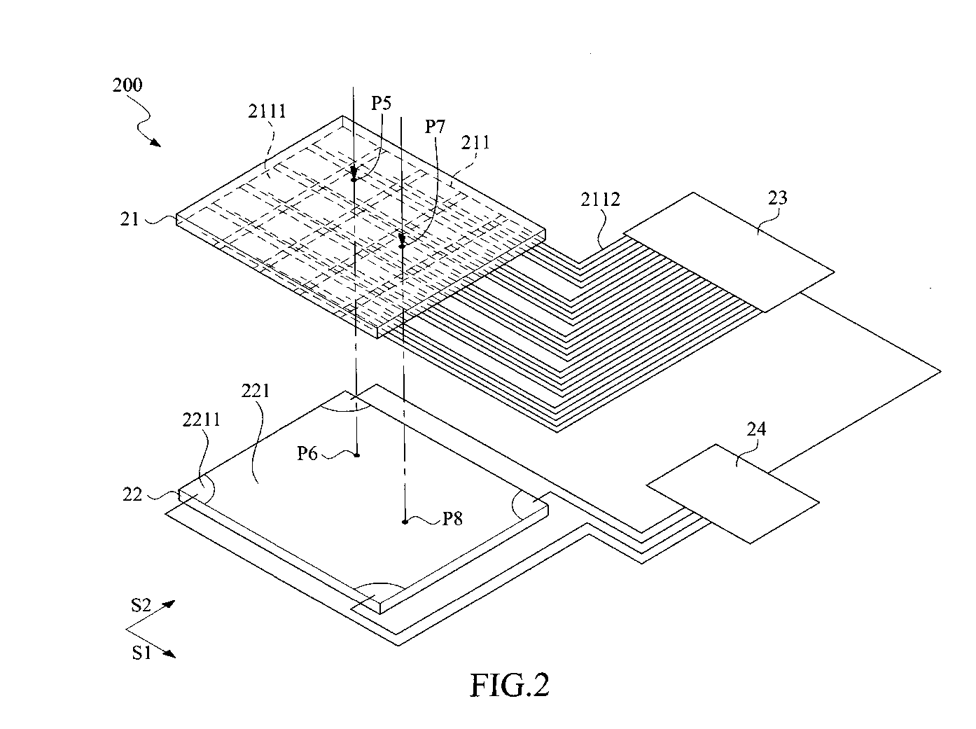

Referring now to FIG. 2, a first embodiment of the resistance type touch panel in accordance with the present invention is explodedly shown. The resistance type touch panel 200 includes a first substrate 21, a second substrate 22 and a detection module 23.

The first substrate 21 includes a touch module 211 located at a bottom surface thereof that faces and opposes to the second substrate 22. The touch module 211 has a plurality of conductive blocks 2111, isolated electrically to each other. Each of the conductive blocks 2111 has a signal line 2112. In the present invention, the first substrate 21 can be made of a polyethylene terephthalate (PET) or a glass. The touch module 211 can be made of an indium tin oxide (ITO) or an antimony doped tin oxide (ATO). Preferably as shown, the conductive blocks 2111 are arranged in a matrix manner, either in a square shape or a rectangular shape.

The second substrate 22 includes a bias-layer module 221 located at an upper surface thereof opposing to the touch module 211. The bias-layer module 221 further includes at least four bias points 2211 accounted for at least two voltage biases along two orthogonal directions, S1 and S2 as shown. The bias-layer module 221 includes a homogeneous plane resistance layer. The bias points 2211 are preferably located at corners of the resistance layer (four corners as shown). In the present invention, the second substrate 22 can be made of a PET or a glass, while the bias-layer module 221 can be made of an ITO or an ATO.

The detection module 23 is electrically coupled with the signal lines 2112 of the touch module 211 at the first substrate 21 for detecting all the voltage changes among the conductive blocks 2111.

In the present invention, the resistance type touch panel 200 further includes a control module 24 connected electrically with the bias points 2111 so as to provide bias voltages across these bias points 2111. The control module 24 is also connected electrically to the detection module 23. Based on the voltages of the conductive blocks 2111 detected by the detection module 23 (shorted from touches at the bias-layer module 221 of the second substrate 220, the touches on the first substrate 21, single or plural, can be determined by the detection module 23 and the control module 24.

In a typical operation of the touch panel 200 according to the present invention, the control module 24 provides voltages to the bias points 2211 in an alternative manner so as to form an S1-S2 orthogonal voltage change on the bias-layer module 221. Referred to FIG. 2, in the case that double touches upon points P5 and P7 at the first substrate 21 are encountered, corresponding local deflections of the first substrate 21 would touch points P6 and P8 respectively at the second substrate 22. As a result, respective conductive paths will be immediately established between P5 and P6 and between P6 and P8. Thereby, respective voltage drops would be detected at two conductive blocks 2111 of the first substrate 21, one for P5 and another for P7. In the present invention, the voltage drop (or the voltage signal) of a specific conductive block 2111 at the first substrate 21 is detected by the detection module 23 through the signal line 2112 accounting to the conductive block 2111. The voltage signal is then forwarded to the control module 24 from the detection module 23 for further judgment upon the location of the touch point. For the signal lines 2112 of the conductive blocks 2111 are isolated (or insulated) electrically to each other in the present design, the detection module 23 and the control module 24 can easily distinguish all the received voltage signals, and thus can tell the coordinates of all the coincident touch points at the first substrate 21.

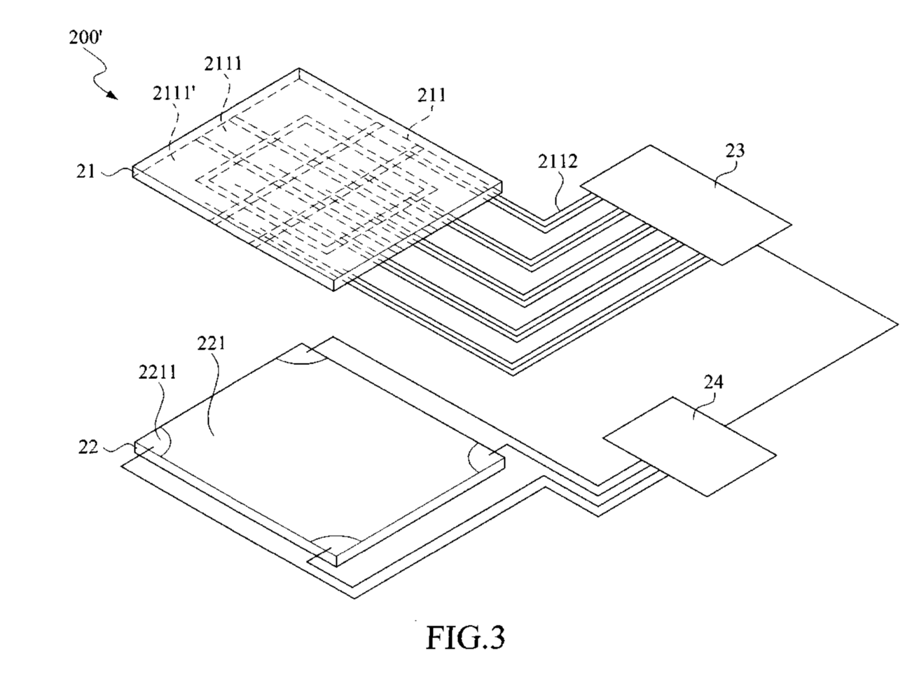

Referring now to FIG. 3, an exploded view of a second embodiment of the resistance type touch panel in accordance with the present invention is shown. Compared to the first embodiment 200 of FIG. 2, the touch panel 200′ of this second embodiment uses less numbers of the conductive blocks 2111′. In FIG. 2, the conductive blocks 2111 are insulated to each other and formed in a grid manner. On the other hand, in FIG. 3, the conductive blocks 2111′ are formed in an overlapping-rectangle manner. It is obvious to see that the locating of the touch points at the first substrate 21 of FIG. 2 would be much more straight-forward than that at the first substrate 21′ of FIG. 3. Yet, the wiring cost for the touch panel 200′ of FIG. 3 would be less than that for the touch panel 200 of FIG. 2.

In the second embodiment of the present invention, the location of the touch point can be determined by comparisons among voltage signals of all the conductive blocks 2111′ who surround the touch point. Algorithms for such comparisons are many and well known in the art, and thus would be omitted herein.

By providing the resistance type touch panel of the present invention, detection of plural coincident touch points on the same substrate is then feasible, and versatile new applications of the touch panel can then be foreseen in the marketplace.

While the present invention has been particularly shown and described with reference to a preferred embodiment, it will be understood by those skilled in the art that various changes in form and detail may be without departing from the spirit and scope of the present invention.

I claim:

1. A resistance type touch panel, comprising:
a first substrate, having a touch module at a bottom surface thereof, the touch module further having thereon a plurality of conductive blocks, each of the conductive blocks including a signal line and being insulated electrically to the other conductive blocks;
a second substrate, having a bias-layer module at an upper surface thereof to oppose to the touch module, the bias-layer module further including at least four bias points accounted for at least two voltage biases along two directions;
a detection module, electrically coupled with each of the signal lines of the touch module at the first substrate for detecting all voltage changes among the conductive blocks.

2. The resistance type touch panel according to claim 1, wherein said bias-layer module includes a plane resistance layer.

3. The resistance type touch panel according to claim 1, wherein said at least four bias points include four said bias points located individually to four corners of said bias-layer module.

4. The resistance type touch panel according to claim 1, wherein said two direction are two orthogonal directions.

5. The resistance type touch panel according to claim 1, further including a control module electrically connected between said bias-layer module and said detection module for providing bias voltages to said bias points and determining touch points on said first substrate from said voltage changes detected by said detection module.

6. The resistance type touch panel according to claim 1, wherein said conductive blocks are formed in a grid manner.

7. The resistance type touch panel according to claim 1, wherein said conductive blocks are formed in an overlapping-rectangle manner.
